(19) United States
(12) Patent Application Publication
(10) Pub. No.: US 2013/0153533 A1
(43) Pub. Date: Jun. 20, 2013

(54) METHOD FOR TUNING WAVELENGTH OF OPTICAL DEVICE USING REFRACTIVE INDEX QUASI-PHASE CHANGE AND ETCHING

(71) Applicants: Sahnggi PARK, Daejeon (KR); Gyungock KIM, Daejeon (KR)

(72) Inventors: Sahnggi PARK, Daejeon (KR); Gyungock KIM, Daejeon (KR)

(73) Assignee: Electronics and Telecommunications Research Institute, Daejeon (KR)

(21) Appl. No.: 13/612,467

(22) Filed: Sep. 12, 2012

(30) Foreign Application Priority Data
Dec. 16, 2011 (KR) 10-2011-0136709

(51) Int. Cl. B05D 5/06; B05D 3/10

(52) U.S. Cl. 216/24; 427/162

(57) ABSTRACT

Methods for tuning a wavelength of an optical device are provided. According to the method, a core pattern may be formed on a substrate, a dielectric layer may be formed to cover the core pattern, and the dielectric layer may be thermally treated to increase a refractive index of the dielectric layer. The dielectric layer may include a silicon oxynitride layer.

### CROSS-REFERENCE TO RELATED APPLICATIONS

This U.S. non-provisional patent application claims priority under 35 U.S.C. §119 to Korean Patent Application No. 10-2011-0136709, filed on Dec. 16, 2011, the entirety of which is incorporated by reference herein.

### BACKGROUND

The inventive concept relates to an optical device and, more particularly, to methods for tuning a wavelength of an optical device using refractive index quasi-phase change and etching.

A light source, a photo detector, an optical switch, an optical modulator, and/or a MUX/DEMUX filter may be used as optical devices in an optical communication technique. Silica optical devices may be used as an optical splitter and a wavelength division device in an optical fiber communication. Polymer optical devices may also be used as a light source and an optical sensor of compound semiconductor, in company with the silica optical devices.

The optical devices such as the optical switch, the optical modulator, the MUX/DEMUX filer may have different functions from each other. However, the optical devices having different functions may share a basic technology or the same device may be applied to various functional devices. The optical devices may commonly have wavelength dependence that the optical devices are normally operated at a specific wavelength. For example, a core layer and a dielectric layer used as an optical waveguide may guide a light of a specific wavelength band.

Generally, if the optical device is manufactured, the light wavelength band of the optical device may be fixed. Thus, it is difficult to apply the manufactured optical device to various kinds of optical devices. Thus, it may be required to develop optical devices capable of changing operation wavelength of optical devices according to temperature change of surroundings, device manufacturing processes, and/or desired light sources.

### SUMMARY

Embodiments of the inventive concept may provide methods for tuning a wavelength of an optical device capable of changing an operation wavelength band of the optical device.

In one aspect, a method for tuning a wavelength of an optical device may include: forming an optical device including a core pattern on a substrate and a dielectric layer covering the core pattern; and thermally treating the optical device to increase a refractive index of the dielectric layer. The dielectric layer may include a silicon oxynitride (SiON) layer.

In some embodiments, the optical device may be thermally treated at a deposition temperature or more of the dielectric layer.

In other embodiments, thermally treating the optical device to increase a refractive index of the dielectric layer may include: thermally treating the dielectric layer to partially phase-change oxygen or nitrogen in the dielectric layer.

In still other embodiments, thermally treating the optical device to increase a refractive index of the dielectric layer may include: partially and thermally treating the optical device to increase a refractive index of a specific region of the dielectric layer.

In yet other embodiments, the core pattern may include at least one of a silicon (Si) layer, a silicon nitride (Si₃N₄) layer, a tantalum oxide (Ta₂O₅) layer, a hafnium oxide (HfO₂) layer, and a doped silicon oxide (doped SiO₂) layer.

In yet still other embodiments, forming the optical device may include: forming the dielectric layer covering a top surface of the core pattern or the top surface and a sidewall of the core pattern by a deposition process.

In yet still other embodiments, forming the optical device may further include: forming a lower cladding layer between the substrate and the core pattern. The lower cladding layer may include a silicon oxide (SiO₂) layer.

In yet still other embodiments, forming the optical device may further include: forming an upper cladding layer covering the dielectric layer. The upper cladding layer may include a silicon oxide (SiO₂) layer and/or a polymer layer.

In another aspect, a method for tuning a wavelength of an optical device may include: forming an optical device including a core pattern on a substrate, a dielectric layer covering the core pattern, and a cladding layer covering the dielectric layer; and etching the cladding layer to reduce a refractive index of the cladding layer.

In some embodiments, etching the cladding layer to reduce the refractive index of the cladding layer may include: etching the cladding layer until the dielectric layer is exposed.

In other embodiments, the method may further include: etching a portion of the dielectric layer to reduce a refractive index of the dielectric layer.

In still other embodiments, the core pattern may include at least one of a silicon (Si) layer, a silicon nitride (Si₃N₄) layer, a tantalum oxide (Ta₂O₅) layer, a hafnium oxide (HfO₂) layer, and a doped silicon oxide (doped SiO₂) layer.

In yet other embodiments, the dielectric layer may include a silicon oxynitride (SiON) layer.

In yet still other embodiments, the cladding layer may include a silicon oxide (SiO₂) layer and/or a polymer layer.

In yet still other embodiments, forming the optical device may include: forming the dielectric layer covering a top surface of the core pattern or the top surface and a sidewall of the core pattern by a deposition process.

In yet still other embodiments, forming the optical device may further include: forming a lower cladding layer between the substrate and the core pattern. The lower cladding layer may include a silicon oxide (SiO₂) layer.

### BRIEF DESCRIPTION OF THE DRAWINGS

The inventive concept will become more apparent in view of the attached drawings and accompanying detailed description.

FIGS. 1A to 1D are cross-sectional views illustrating a method of manufacturing an optical device according to some embodiments of the inventive concept;

FIGS. 2A to 2D are cross-sectional views illustrating a method for tuning a wavelength of an optical device according to some embodiments of the inventive concept;

FIGS. 3A to 3E are cross-sectional views illustrating a method of manufacturing an optical device according to other embodiments of the inventive concept;

FIGS. 4A to 4D are cross-sectional views illustrating a method for tuning a wavelength of an optical device according to other embodiments of the inventive concept;

FIG. 5A is a transmission spectrum showing change of a resonance wavelength of a ring resonator according to a time when a ring resonator formed by some embodiments of the inventive concept is thermally treated at about 400 degrees Celsius;

FIG. 5B is a graph showing a wavelength shift of a ring resonator according to a temperature when a ring resonator formed by some embodiments of the inventive concept is thermally treated; and

FIG. 5C is a graph showing a wavelength shift of a ring resonator according to a time when a ring resonator formed by some embodiments of the inventive concept is thermally treated at a specific temperature.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms.

Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

According to embodiments of the inventive concept, after a silicon oxynitride (SiOₓN_{y}) may be deposited at a specific temperature by a plasma enhanced chemical vapor deposition (PECVD) apparatus, the deposited silicon oxynitride may be heated at an increased temperature. Thus, a refractive index quasi-phase change phenomenon may occur. The refractive index quasi-phase change phenomenon means that a refractive index of a deposited layer is hardly or a bit changed at a temperature under a deposition temperature thereof but greatly increases at a temperature equal or greater than the deposition temperature. Thus, if the silicon oxynitride layer is included in an upper cladding layer of a waveguide, a resonance wavelength of a ring resonator may be easily and accurately changed.

The above feature may relate to a sublimation phenomenon of the deposited silicon oxynitride layer. A bonding force between silicon and nitrogen (Si—N) may be different from a bonding force between silicon and oxygen (Si—O), so that a phase-change temperature of the nitrogen may be different from a phase-change temperature of the oxygen. Since the refractive index of the silicon oxynitride layer increases, the phase-change temperature of the oxygen may be lower than the phase-change temperature of the nitrogen. A refractive index of a silicon oxide layer (SiO₂) may be about 1.45, a refractive index of a silicon nitride layer (Si₃N₄) may be about 2.0, and the refractive index of the oxynitride layer (SiOₓN_{y}) may have a value within a range of about 1.45 to about 2.0 according to a ratio of the oxygen and the nitrogen. The silicon oxynitride layer may be phase-changed at about the deposition temperature thereof and the phase-change temperatures of the oxygen and the nitrogen may be different from each other, such that the refractive index quasi-phase change may occur. As described above, the refractive index quasi-phase change may mean that the refractive index of the silicon oxynitride layer is rapidly changed at the deposition temperature thereof. This will be described in more detail hereinafter.

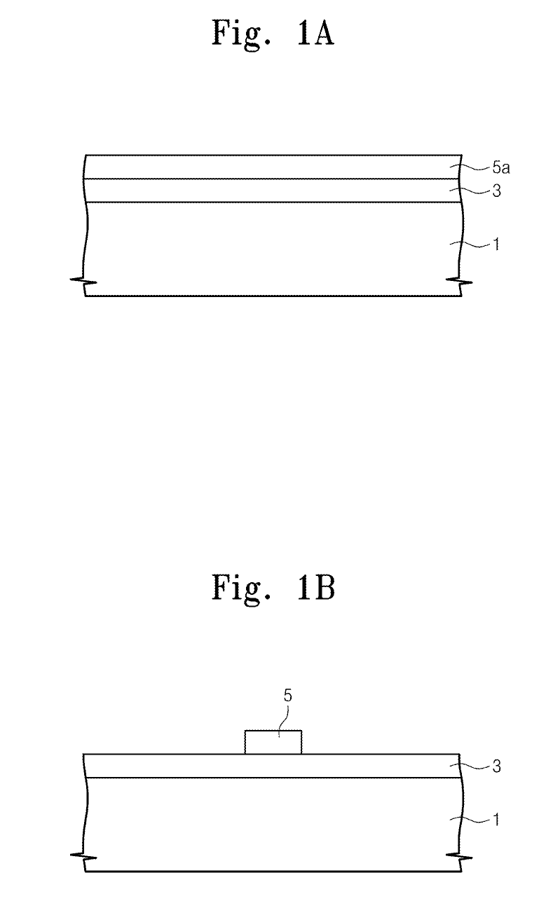

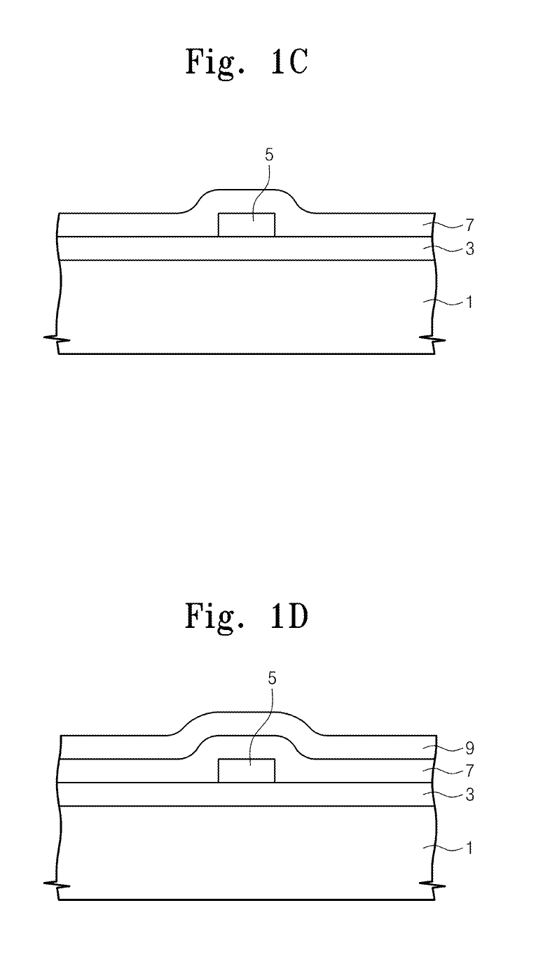

FIGS. 1A to 1D are cross-sectional views illustrating a method of manufacturing an optical device according to some embodiments of the inventive concept.

Referring to FIG. 1A, a lower cladding layer 3 may be formed on a substrate 1. The substrate 1 may be a silicon substrate, a silicon-on-insulator (SOI) substrate, or a glass substrate. The lower cladding layer 3 may be formed of a silicon oxide layer (SiO₂). A thickness of the lower cladding layer 3 may be suitably controlled according to characteristics of optical devices without a limit. For example, the lower cladding layer 3 may be formed to have a thickness of about 5000 nm (or about 5 μm) or less in order that it prevents impurities from being inputted from the outside of the optical device and does not influence an optical waveguide which is formed to have a thickness of about 100 nm or more.

During a subsequent process for forming a core pattern 5, the lower cladding layer 3 may prevent impurities within the core pattern 5 from diffusing out. Additionally, the lower cladding layer 3 may also function as an etch stop layer when a core layer 5a is etched.

The core layer 5a may be formed on the lower cladding layer 3. The core layer 5a may include a material having a refractive index greater than that of the lower cladding layer 3. For example, the core layer 5a may include at least one of a silicon (Si) layer, a doped silicon oxide (doped SiO₂) layer, a silicon nitride (Si₃N₄) layer, a tantalum oxide (Ta₂O₅) layer, and a hafnium oxide (HfO₂) layer. Each of the lower cladding layer 3 and the core layer 5a may be formed using a deposition process. For example, each of the lower cladding layer 3 and the core layer 5a may be formed by a plasma enhanced chemical vapor deposition (PECVD) process or a low pressure CVD (LPCVD) process.

Alternatively, the substrate 1 may be a SOI substrate including the lower cladding layer 3 and the core layer 5a. In this case, the lower cladding layer 3 may include a silicon oxide layer and the core layer 5a may include a silicon layer.

Referring to FIG. 1B, the core layer 5a may be etched to from a core pattern 5. A photoresist may be exposed and then developed to form a photoresist pattern (now shown) defining the core pattern 5 on the core layer 5a. The core layer 5a may be etched using the photoresist pattern as an etch mask, thereby forming the core pattern 5. Thereafter, the photoresist pattern may be removed. The core pattern 5 may be used as an optical waveguide through which a light of an optical device passes.

Referring to FIG. 1C, an assistant dielectric layer 7 may be formed on the substrate 1 provided with the core pattern 5. The assistant dielectric layer 7 may be a silicon oxynitride (SiON) layer. The assistant dielectric layer 7 may be formed using a deposition process, for example, a PECVD process or a LPCVD process. For example, the assistant dielectric layer 7 may have a thickness a substantially equal to the thickness of the lower cladding layer 3. The assistant dielectric layer 7 may cover the core pattern 5. The assistant dielectric layer 7 may protect the core pattern 5. The assistant dielectric layer 7 and the core pattern 5 may be used as the optical waveguide.

Referring to FIG. 1D, an upper cladding layer 9 may be formed on the assistant dielectric layer 7. A distribution of a refractive index may be substantially uniform in the upper cladding layer 9. The upper cladding layer 9 may be formed of a material having a refractive index lower than that of the core pattern 5. The upper cladding layer 9 may be formed of a silicon oxide (SiO₂) layer and/or a polymer layer (e.g., imide and/or acrylate).

The upper cladding layer 9 may be formed by a deposition process, for example, a PECVD process, a LPCVD process, or an atmospheric pressure CVD (APCVD) process. After the deposition process, the upper cladding layer 9 may be thermally treated at a high temperature in order to have a substantially uniform refractive index distribution. The lower and upper cladding layers 3 and 9 may be formed of the same material in order to have the same refractive index.

A structure of the optical device according to the present embodiment may be applied to an arrayed wave guide grating (AWG) and/or an Echelle grating as well as a silicon ring resonator.

In the present embodiment, since the assistant dielectric layer 7 covers the core pattern 5 and is formed of a silicon oxynitride layer, a light wavelength of the optical device may be changeable. This will be described in detail hereinafter.

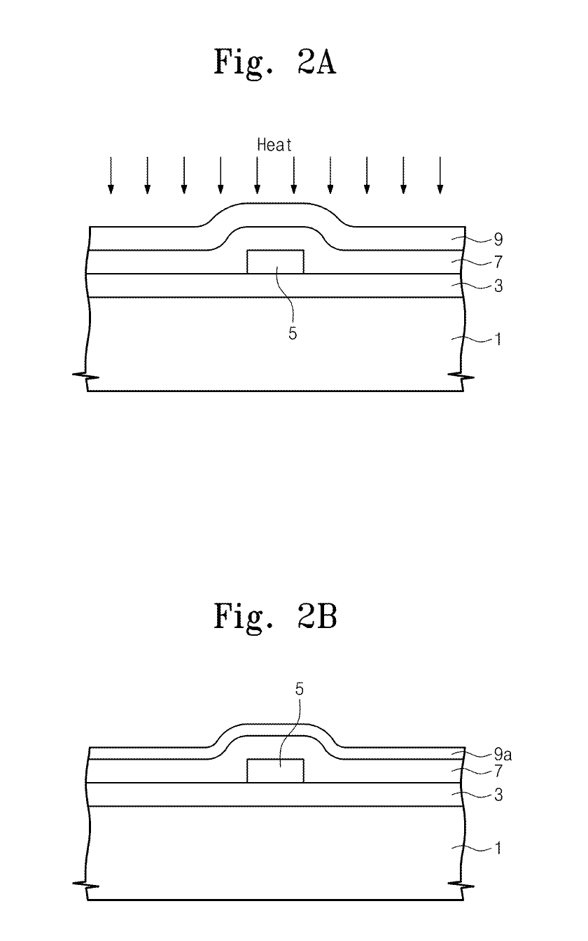

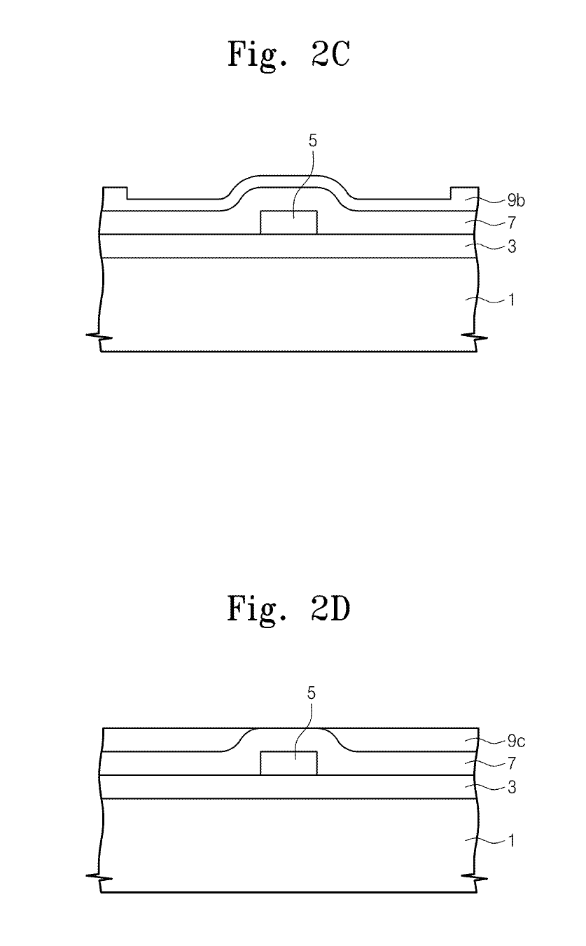

FIGS. 2A to 2D are cross-sectional views illustrating a method for tuning a wavelength of an optical device according to some embodiments of the inventive concept.

Referring to FIG. 2A, the optical device manufactured by the method described with reference to FIGS. 1A and 1D may be thermally treated for increasing a wavelength of the core pattern 5.

If a temperature of the optical device increases by the thermal treatment, the refractive index quasi-phase change phenomenon may be induced in the assistant dielectric layer 7. As described above, the refractive index quasi-phase change phenomenon means that a refractive index of a specific material is hardly or a bit changed at a temperature under the deposition temperature thereof but greatly increases at a temperature equal or greater than the deposition temperature.

In other words, when the assistant dielectric layer 7 formed of the silicon oxynitride layer is phase-changed at about the deposition temperature of the assistant dielectric layer 7 by the thermal treatment, the refractive index quasi-phase change phenomenon may occur in the assistant dielectric layer 7 by the difference between phase-change temperatures of the oxygen and the nitrogen. Thus, the refractive index of the assistant dielectric layer 7 may be rapidly changed at about the deposition temperature. The deposition temperature may be about 400 degrees Celsius.

In more detail, if the assistant dielectric layer 7 provided with the silicon oxynitride layer is thermally treated at the deposition temperature or more, the bonding force between silicon and nitrogen (Si—N) is different from the bonding force between silicon and oxygen (Si—O), such that the nitrogen and the oxygen may be phase-changed at temperatures different from each other, respectively. For example, the bonding force between the silicon and oxygen (Si—O) may be weaker than the bonding force between the silicon and nitrogen (Si—N), so that the oxygen may be phase-changed at a temperature lower than the temperature at which the nitrogen is phase-changed. A refractive index of a silicon nitride layer is greater than a refractive index of a silicon oxide layer. Thus, since the oxygen is phase-changed prior to phase-change of the nitrogen, the refractive index of the assistant dielectric layer 7 may increase.

The refractive index of the silicon oxide layer (SiO₂) may be about 1.45, the refractive index of the silicon nitride layer (Si₃N₄) may be about 2.0, and the refractive index of the oxynitride layer (SiOₓN_{y}) may have a value within a range of about 1.45 to about 2.0 according to a ratio of the oxygen and the nitrogen.

Since the assistant dielectric layer 7 is thermally treated, the refractive index of the assistant dielectric layer 7 may increase. Thus, it is possible to increase a wavelength of the light passing through the assistant dielectric layer 7 and the core pattern 5. As a result, an operation wavelength of the optical device operated at a specific wavelength may be easily changed, such that the optical device with high reliability may be realized.

Referring to FIG. 2B, the upper cladding layer 9a may be etched for reducing the light wavelength of the optical device manufactured by the method described with reference to FIGS. 1A to 1D.

An entire surface of the upper cladding layer 9 of FIG. 2A may be etched to form an upper cladding layer 9a having a thin thickness as illustrated in FIG. 2B. The upper cladding layer 9 may be etched using a dry or wet etching process. For example, the dry etching process may include a reactive ion etching (RIE) process, and the wet etching process may use a HF solution.

Since the upper cladding layer 9a becomes thin by the etching process, the refractive index of the optical device may be reduced. For example, the upper cladding layer 9a may be formed of the silicon oxide layer having the refractive index of about 1.45, and the assistant dielectric layer 7 may be formed of the silicon oxynitride layer having the refractive index within the range of about 1.45 to about 2.0. The air outside the upper cladding layer 9a has a refractive index of about 1.0. Thus, since the upper cladding layer 9a becomes thin by the etching process, the refractive index of the optical device may be reduced.

As described above, since the upper cladding layer 9a becomes thin by the etching process, the refractive index of the optical device may be reduced. Thus, it is possible to reduce the wavelength of the light passing through the assistant dielectric layer 7 and the core pattern 5. As a result, the operation wavelength of the optical device operated at a specific wavelength may be easily changed, such that the optical device with high reliability may be realized.

The thickness of the upper cladding layer 9a may not be limited. The upper cladding layer 9a formed by the etching process may have various shapes. The thickness and the shape of the upper cladding layer 9a may be suitably controlled according to characteristics of the optical devices using the upper cladding layer 9a.

As illustrated in FIG. 2C, an upper cladding layer 9b may be partially etched. The etching process may include a dry or wet etching process. Since the upper cladding layer 9b is partially etched, the refractive index of the optical device may be controlled.

Referring to FIG. 2D, an upper cladding layer 9c may be etched until a top surface of the assistant dielectric layer 7 on the core pattern 5 is exposed. In this case, the top surface of the assistant dielectric layer 7 may also be etched. For example, the assistant dielectric layer 7 may be formed of the silicon oxynitride layer having the refractive index of about 1.45 to about 2.0 and the air outside the assistant dielectric layer 7 has the refractive index of about 1. Thus, since the assistant dielectric layer 7 is etched to become thin, the refractive index of the optical device may be more reduced.

As described above, since the upper cladding layer 9c and the assistant dielectric layer 7 are etched, the refractive index of the optical device may be reduced. Thus, it is possible to reduce a wavelength of the light passing through the assistant dielectric layer 7 and the core pattern 5. As a result, the operation wavelength of the optical device operated at a specific wavelength may be easily changed, such that the optical device with high reliability may be realized.

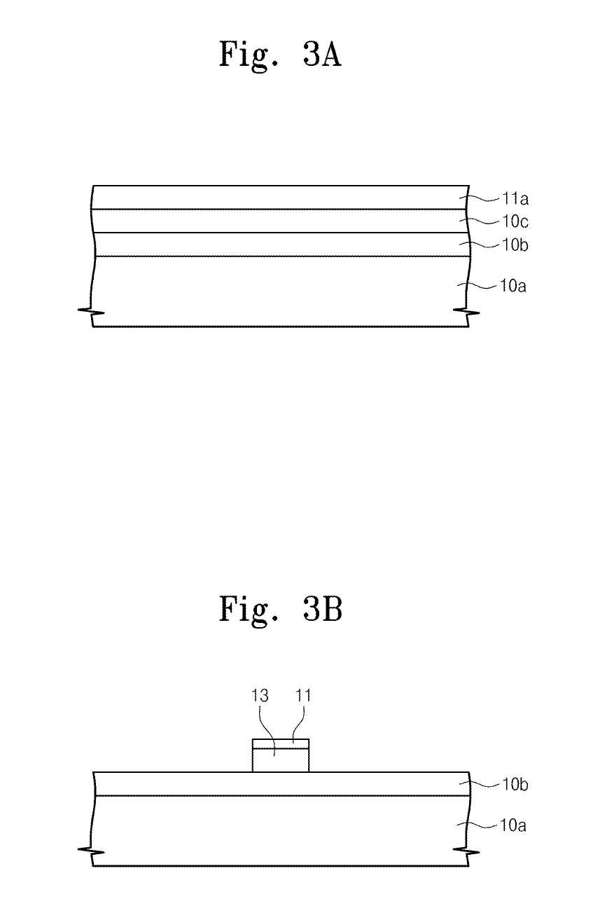

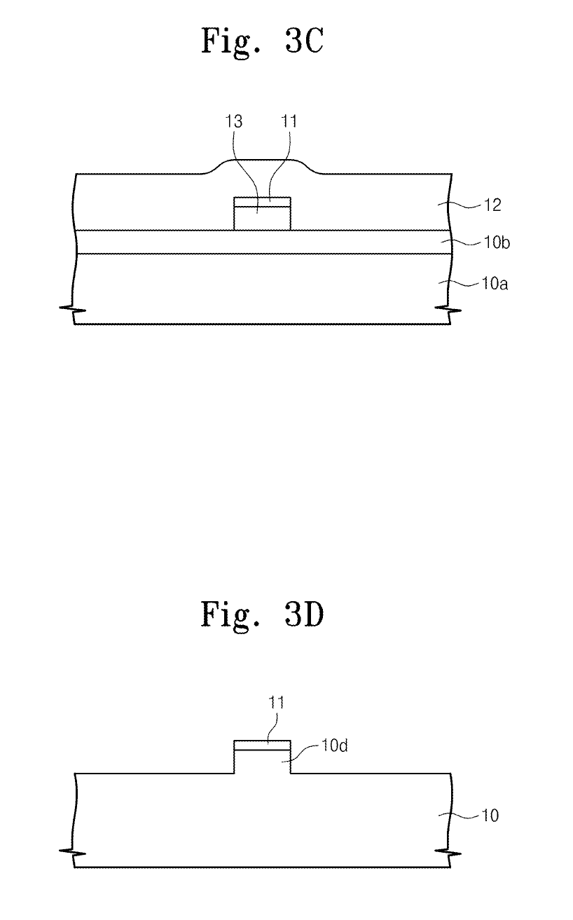

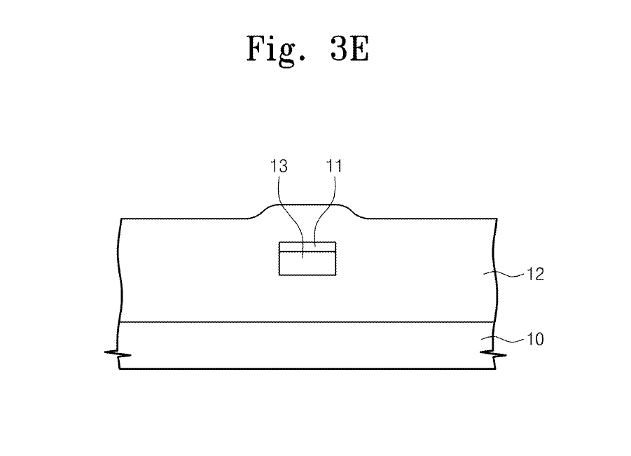

FIGS. 3A to 3E are cross-sectional views illustrating a method of manufacturing an optical device according to other embodiments of the inventive concept.

Referring to FIG. 3A, a lower cladding layer 10b, a core layer 10c, and an assistant dielectric layer 11a may be sequentially formed on a substrate 10a. The substrate 10a may be a silicon substrate or a glass substrate. The lower cladding layer 10b may include a silicon oxide (SiO₂) layer. The core layer 10c may include at least one of a silicon (Si) layer, a doped silicon oxide (doped SiO₂) layer, a silicon nitride (Si₃N₄) layer, a tantalum oxide (Ta₂O₅) layer, and a hafnium oxide (HfO₂) layer.

Each of the lower cladding layer 10b and the core layer 10c may be formed using a deposition process, for example, a PECVD process or a LPCVD process.

Alternatively, the substrate 10a may be a SOI substrate including the lower cladding layer 10b and the core layer 10c. In this case, the lower cladding layer 10b may include a silicon oxide layer and the core layer 10c may include a silicon layer.

Referring to FIG. 3B, a photoresist may be exposed and then developed to form a photoresist pattern (now shown) defining the core pattern. The assistant dielectric layer 11a and the core layer 10c may be etched using the photoresist pattern as an etch mask, thereby forming a core pattern 13 and an assistant dielectric pattern 11. Thereafter, the photoresist pattern may be removed. The assistant dielectric pattern 11 may be formed to cover a top surface of the core pattern 13.

Referring to FIG. 3C, an upper cladding layer 12 may be formed to cover the core pattern 13 and the assistant dielectric pattern 11. The upper cladding layer 12 may cover entire surfaces of the core pattern 13 and the assistant dielectric pattern 11.

The upper cladding layer 12 may be formed using a deposition process, for example, a PECVD process or a LPCVD process.

In other embodiments, referring to FIG. 3D, an assistant dielectric layer may be formed on a substrate 10 and then be etched to form a protrusion 10d of the substrate 10 and the assistant dielectric pattern 11.

Referring to FIG. 3E, the substrate 10 may be thermally oxidized to form a cladding layer 12. Thus, a core pattern 13 and the assistant dielectric pattern 11 spaced apart from the substrate 10 may be formed. Subsequently, a material layer for the cladding layer 12 may further be deposited. Thus, the cladding layer 12 may be formed to cover entire surfaces of the core pattern 13 and the assistant dielectric pattern 11. The assistant dielectric pattern 11 and the core pattern 13 may be used as the optical waveguide.

In the optical device according to the present embodiment, the assistant dielectric pattern 11 may be formed of the silicon oxynitride layer and cover the top surface of the core pattern 13. Thus, the light wavelength of the optical device may be tuned.

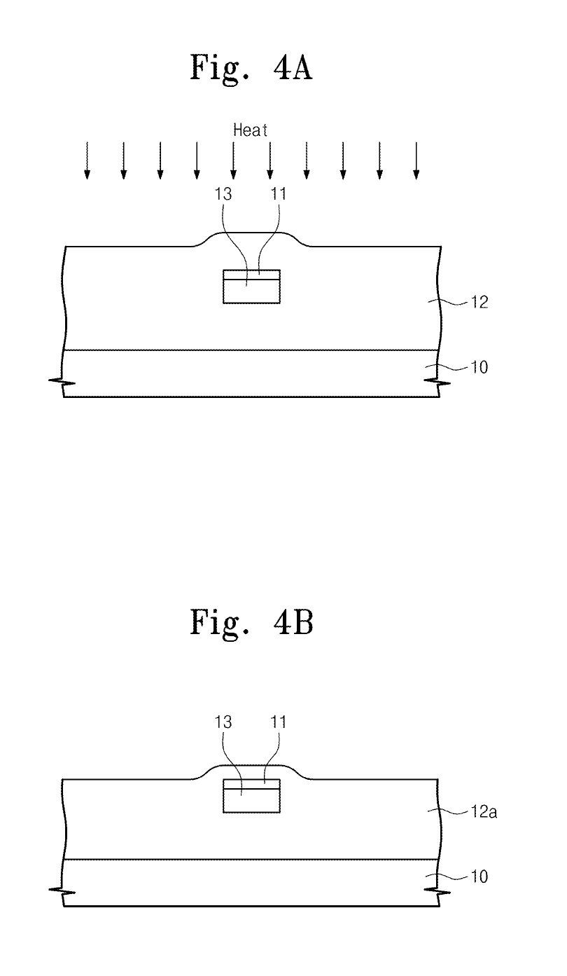

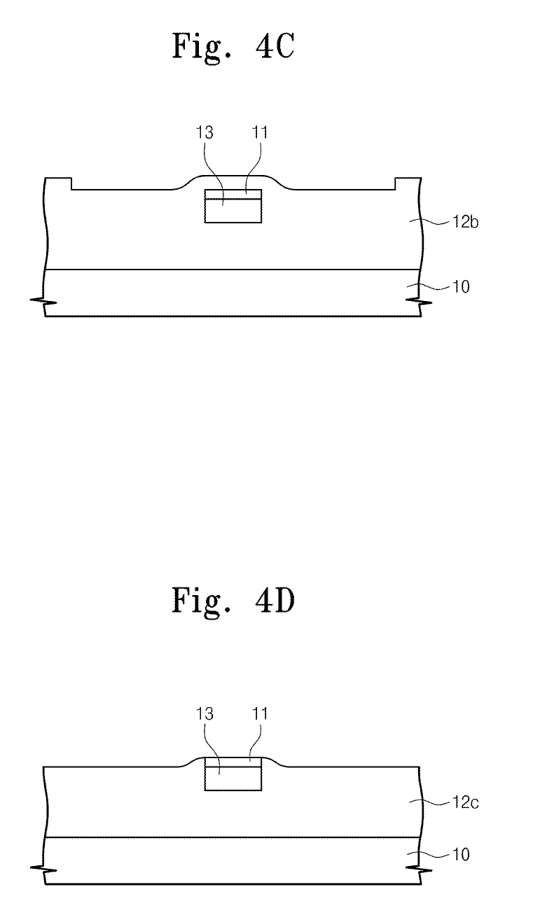

FIGS. 4A to 4D are cross-sectional views illustrating a method for tuning a wavelength of an optical device according to other embodiments of the inventive concept.

Referring to FIG. 4A, the optical device manufactured by the method described in FIGS. 3A to 3E may be thermally treated for increasing a wavelength of the core pattern 13 thereof. FIGS. 4A to 4D illustrates the method for tuning the wavelength of the optical device illustrated in FIG. 3E as an example. However, the inventive concept is not limited thereto.

If the temperature of the optical device increases by the thermal treatment, the refractive index quasi-phase change phenomenon may be induced in the assistant dielectric pattern 11. In other words, if the assistant dielectric pattern 11 formed of the silicon oxynitride layer is thermally treated at the deposition temperature or more of the silicon oxynitride layer, the bonding force between silicon and nitrogen (Si—N) is different from the bonding force between silicon and oxygen (Si—O), such that the nitrogen and the oxygen may be phase-changed at temperatures different from each other, respectively. For example, the bonding force between the silicon and oxygen (Si—O) may be weaker than the bonding force between the silicon and the nitrogen (Si—N), so that the oxygen may be phase-changed at a temperature lower than the temperature at which the nitrogen is phase-changed. A refractive index of a silicon nitride layer is greater than a refractive index of a silicon oxide layer. Thus, since the oxygen is phase-changed prior to phase-change of the nitrogen, the refractive index of the assistant dielectric pattern 11 may increase. A temperature of the thermal treatment may be determined depending on the deposition temperature of the assistant dielectric pattern 11 and be about 400 degrees Celsius.

Since the assistant dielectric pattern 11 is thermally treated, the refractive index of the assistant dielectric pattern 11 may increase. Thus, it is possible to increase a wavelength of the light passing through the assistant dielectric pattern 11 and the core pattern 13. As a result, the operation wavelength of the optical device operated at a specific wavelength may be easily changed, such that the optical device with high reliability may be realized.

Referring to FIG. 4B, the cladding layer 12 may be etched for reducing a light wavelength of the optical device manufactured by the method described with reference to FIGS. 3A to 3E.

An entire surface of the cladding layer 12 may be etched to form a cladding layer 12a having a thin thickness as illustrated in FIG. 4B. The cladding layer 12 may be etched using a dry or wet etching process. For example, the dry etching process may include a reactive ion etching (RIE) process. The wet etching process may use a HF solution.

Since the cladding layer 12a becomes thin by the etching process, the refractive index of the optical device may be reduced. For example, the cladding layer 12a may be formed of the silicon oxide layer having the refractive index of about 1.45, and the assistant dielectric pattern 11 may be formed of the silicon oxynitride layer having the refractive index within the range of about 1.45 to about 2.0. The air outside the cladding layer 12a has a refractive index of about 1.0. Thus, since the cladding layer 12a becomes thin by the etching process, the refractive index of the optical device may be reduced.

The thickness of the cladding layer 12a may not be limited. The cladding layer 12a formed by the etching process may have various shapes. The thickness and the shape of the cladding layer 12a may be suitably controlled according to characteristics of the optical devices using the cladding layer 12a.

As illustrated in FIG. 4C, a cladding layer 12b may be partially etched. The etching process may include a dry or wet etching process. Since the cladding layer 12b is partially etched, the refractive index of the optical device may be controlled.

Referring to FIG. 4D, a cladding layer 12c may be etched until a top surface of the assistant dielectric pattern 11 on the core pattern 13 is exposed. In this case, the top surface of the assistant dielectric pattern 11 may also be etched. For example, the assistant dielectric pattern 11 may be formed of the silicon oxynitride layer having the refractive index of about 1.45 to about 2.0 and the air outside the assistant dielectric layer 7 has the refractive index of about 1. Thus, since the assistant dielectric pattern 11 is etched to become thin, the refractive index of the optical device may be more reduced.

As described above, since the cladding layer 12c and the assistant dielectric pattern 11 are etched, the refractive index of the optical device may be reduced. Thus, it is possible to reduce a wavelength of the light passing through the assistant dielectric pattern 11 and the core pattern 13. As a result, the operation wavelength of the optical device operated at a specific wavelength may be easily changed, such that the optical device with high reliability may be realized.

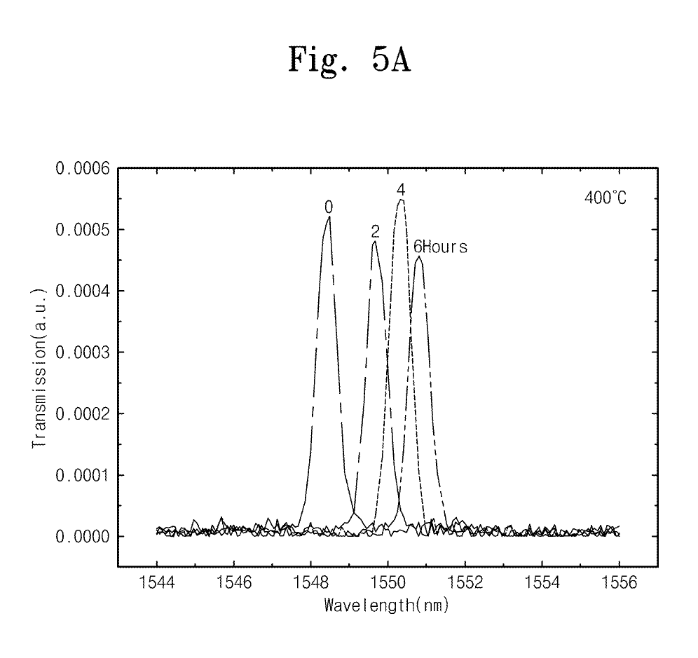

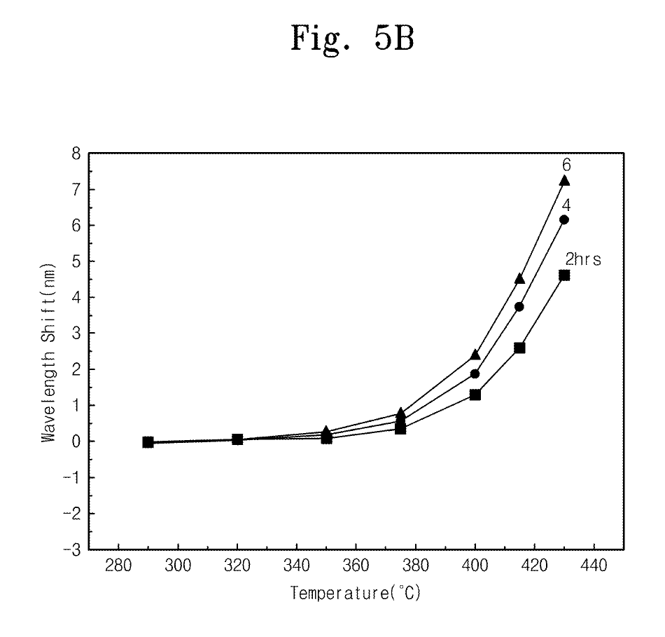

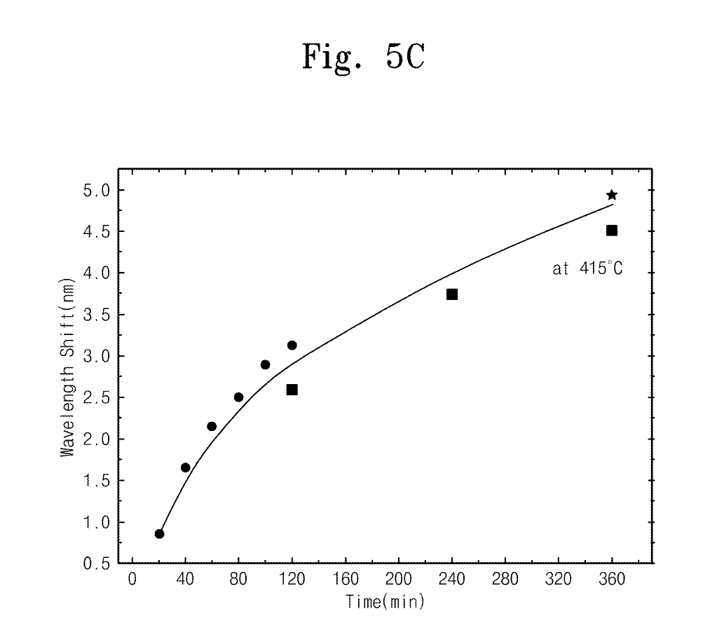

FIG. 5A is a transmission spectrum showing change of a resonance wavelength of a ring resonator according to a time when a ring resonator formed by some embodiments of the inventive concept is thermally treated at about 400 degrees Celsius. FIG. 5B is a graph showing a wavelength shift of a ring resonator according to a temperature when a ring resonator formed by some embodiments of the inventive concept is thermally treated. FIG. 5C is a graph showing a wavelength shift of a ring resonator according to a time when a ring resonator formed by some embodiments of the inventive concept is thermally treated at a specific temperature.

The graphs illustrated in FIGS. 5A to 5C correspond to experiment data using the ring resonator having the structure of the optical device illustrated in FIG. 2A. In the optical device according to the present experiments, the width and the height of the core pattern 5 were about 1000 nm and about 190 nm, respectively. The thickness of the assistant dielectric layer 7 was about 1000 nm, and the thickness of the upper cladding layer 9 was 1000 nm.

Referring to FIG. 5A, the resonance wavelength of the ring resonator increases as the process time of the thermal treatment increases at about 400 degrees Celsius.

Referring to FIG. 5B, the wavelength shifts of the ring resonators are shown in FIG. 5B when the ring resonators were thermally treated for 2 hours, 4 hours, and 6 hours at each of the temperature, respectively. As illustrated in FIG. 5B, the wavelengths are hardly changed irrespectively of the thermal treatment time under about 340 degrees Celsius. But, the wavelengths rapidly increase at about 400 degrees Celsius corresponding to the deposition temperature. Additionally, as the thermal treatment time increases, the changing amount of the wavelength becomes greater.

Referring to FIG. 5C, a wavelength shift with respect to a time is illustrated in FIG. 5C when the ring resonator was thermally treated at about 415 degrees Celsius. In other words, the wavelength of the ring resonator is rapidly varied to about 2 hours corresponding to an initial stage. Thereafter, the variation amount of the wavelength of the ring resonator becomes reduced.

As illustrated in FIGS. 5A to 5C, when the ring resonator according to some embodiments is thermally treated, the resonance wavelength of the ring resonator may increase. In other words, the assistant dielectric layer 7 of FIG. 2A is thermally treated at the deposition temperature or more, so that the refractive index of the assistant dielectric layer 7 may increase. As a result, the resonance wavelength of the ring resonator may increase.

According to embodiments of the inventive concept, the dielectric layer of the optical device may be thermally treated to increase the refractive index of the dielectric layer. Thus, it is possible to increase the wavelength of the light passing through the dielectric layer and the core pattern. As a result, the operation wavelength of the optical device operated at a specific wavelength may be easily changed, such that the optical device with high reliability may be realized.

Additionally, the cladding layer of the optical device may be partially etched to reduce the refractive index of the cladding layer. Thus, it is possible to reduce the wavelength of the light passing through the dielectric layer and the core pattern.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A method for tuning a wavelength of an optical device, comprising:
forming an optical device including a core pattern on a substrate and a dielectric layer covering the core pattern; and
thermally treating the optical device to increase a refractive index of the dielectric layer,
wherein the dielectric layer includes a silicon oxynitride (SiON) layer.

2. The method of claim 1, wherein the optical device is thermally treated at a deposition temperature or more of the dielectric layer.

3. The method of claim 1, wherein thermally treating the optical device to increase a refractive index of the dielectric layer comprises:
thermally treating the dielectric layer to partially phase-change oxygen or nitrogen in the dielectric layer.

4. The method of claim 1, wherein thermally treating the optical device to increase a refractive index of the dielectric layer comprises:
partially and thermally treating the optical device to increase a refractive index of a specific region of the dielectric layer.

5. The method of claim 1, wherein the core pattern includes at least one of a silicon (Si) layer, a silicon nitride (Si₃N₄) layer, a tantalum oxide (Ta₂O₅) layer, a hafnium oxide (HfO₂) layer, and a doped silicon oxide (doped SiO₂) layer.

6. The method of claim 1, wherein forming the optical device comprises:
forming the dielectric layer covering a top surface of the core pattern or the top surface and a sidewall of the core pattern by a deposition process.

7. The method of claim 1, wherein forming the optical device further comprises:
forming a lower cladding layer between the substrate and the core pattern,
wherein the lower cladding layer includes a silicon oxide (SiO₂) layer.

8. The method of claim 1, wherein forming the optical device further comprises:
forming an upper cladding layer covering the dielectric layer,
wherein the upper cladding layer includes a silicon oxide (SiO₂) layer and/or a polymer layer.

9. A method for tuning a wavelength of an optical device, comprising:
forming an optical device including a core pattern on a substrate, a dielectric layer covering the core pattern, and a cladding layer covering the dielectric layer; and
etching the cladding layer to reduce a refractive index of the cladding layer.

10. The method of claim 9, wherein etching the cladding layer to reduce the refractive index of the cladding layer comprises:
etching the cladding layer until the dielectric layer is exposed.

11. The method of claim 10, further comprising:
etching a portion of the dielectric layer to reduce a refractive index of the dielectric layer.

12. The method of claim 9, wherein the core pattern includes at least one of a silicon (Si) layer, a silicon nitride (Si₃N₄) layer, a tantalum oxide (Ta₂O₅) layer, a hafnium oxide (HfO₂) layer, and a doped silicon oxide (doped SiO₂) layer.

13. The method of claim 9, wherein the dielectric layer includes a silicon oxynitride (SiON) layer.

14. The method of claim 9, wherein the cladding layer includes a silicon oxide (SiO₂) layer and/or a polymer layer.

15. The method of claim 9, wherein forming the optical device comprises:
forming the dielectric layer covering a top surface of the core pattern or the top surface and a sidewall of the core pattern by a deposition process.

16. The method of claim 9, wherein forming the optical device further comprises:
forming a lower cladding layer between the substrate and the core pattern,
wherein the lower cladding layer includes a silicon oxide (SiO₂) layer.
